(19) United States
(12) Patent Application Publication
(10) Pub. No.: US 2020/0372520 A1
(43) Pub. Date: Nov. 26, 2020

(54) MEDIA SELECTION AND DELIVERY SCHEDULING

(71) Applicant: International Business Machines Corporation, Armonk, NY (US)

(72) Inventors: Christopher John Hutton, Hurley, NY (US); SCHAYNE BELLROSE, Wappingers Falls, NY (US); Pasquale A. Catalano, Wallkill, NY (US); Prach Jerry Chuaypradit, Apex, NC (US)

(21) Appl. No.: 16/419,251

(22) Filed: May 22, 2019

(51) Int. Cl. G06Q 30/02; G06Q 10/10

(52) U.S. Cl. CPC G06Q 30/0201; G06Q 10/1093

(57) ABSTRACT

Techniques for media selection and delivery scheduling are described herein. An aspect includes determining an available timeslot corresponding to a user based on a calendar that is associated with the user. Another aspect includes determining a user device that is available to the user during the available timeslot. Another aspect includes selecting media for consumption by the user during the available timeslot via the available user device. Another aspect includes causing the selected media to be delivered to the user via the available user device during the available timeslot.

### BACKGROUND

The present techniques relate to computing devices. More specifically, the techniques relate to media selection and delivery scheduling for computing devices.

In the marketplace, there are numerous different types of computing devices available to consumers. Some examples of computing devices may include smart phones, tablets, gaming systems, laptop computers, smart televisions, and the like. Each of these computing devices may include different variations and features as part of their computing platform, in addition to having different processing capabilities and physical characteristics, such as screen size.

### SUMMARY

According to an embodiment described herein, a system can include a processor to determine an available timeslot corresponding to a user based on a calendar that is associated with the user. The processor can also determine a user device that is available to the user during the available timeslot. The processor can also select media for consumption by the user during the available timeslot via the available user device. The processor can also cause the selected media to be delivered to the user via the available user device during the available timeslot.

According to another embodiment described herein, a method can include determining an available timeslot corresponding to a user based on a calendar that is associated with the user. The method can also include determining a user device that is available to the user during the available timeslot. The method can also include selecting media for consumption by the user during the available timeslot via the available user device. The method can also include causing the selected media to be delivered to the user via the available user device during the available timeslot.

According to another embodiment described herein, a computer program product includes a computer readable storage medium having program instructions embodied therewith, the program instructions executable by a processing device to cause the processing device to perform a method including determining an available timeslot corresponding to a user based on a calendar that is associated with the user. The method can also include determining a user device that is available to the user during the available timeslot. The method can also include selecting media for consumption by the user during the available timeslot via the available user device. The method can also include causing the selected media to be delivered to the user via the available user device during the available timeslot.

### BRIEF DESCRIPTION OF THE DRAWINGS

FIG. 1 is a block diagram of an example computer system for use in conjunction with media selection and delivery scheduling;

FIG. 2 is a block diagram of a system for media selection and delivery scheduling in accordance with one or more embodiments of the present invention;

FIG. 3 is a process flow diagram of a method for media selection and delivery scheduling in accordance with one or more embodiments of the present invention;

FIG. 4 is a process flow diagram of another method for media selection and delivery scheduling in accordance with one or more embodiments of the present invention; and

FIG. 5 is a block diagram of a user profile for use in a system for media selection and delivery scheduling in accordance with one or more embodiments of the present invention.

### DETAILED DESCRIPTION

One or more embodiments of the present invention provide media selection and delivery scheduling. A user may have multiple computing devices through which media may be delivered to the user. The user may prefer to consume particular types of media on a particular device type. The user may also have free time in their schedule that goes unutilized. A user may wish to receive media content related to, for example, pursuing a new interest during their free time. Embodiments of media selection and delivery scheduling may find media that is related to topics that are of interest to a user, find an available timeslot in the user's schedule, predict which device(s) may be available to the user during the determined timeslot, and schedule media for delivery to the user that meets the interest criteria in a format that is appropriate to the available device. The media may be selected to have an appropriate length based on the duration of the timeslot and a user media consumption rate for the type of media.

Embodiments may include a user profile that stores a list of computing devices that belong to the user, including various device characteristics and preferences, and a list of user interests with corresponding user interest levels. Calendar data in the user profile may be gathered from multiple calendars that are associated with the user, including, for example, work and personal calendars. Historical schedule and location data of the user may also be collected from, for example, Internet of Things (IoT) devices and personal computing devices that generates global positioning system information (such as a smartphone). Any timeslots in the user's schedule in which the user may wish to consume media may be identified. User media consumption rates may be determined and maintained for various types of media, and may be used to select media that fits the duration of an available timeslot. The user media consumption rate in a user's profile for a particular type of media may be adjusted based on the user's actual media consumption rate. The media may be selected to be in a format that is appropriate for the user's current situation during an available timeslot (e.g., audio-only media while driving during the user's commute).

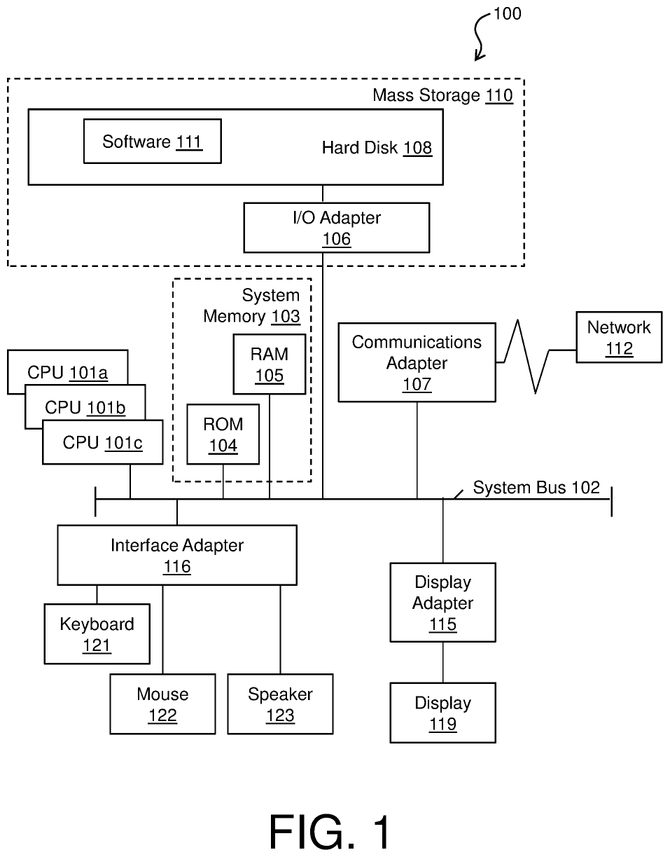

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units, i.e., CPUs 101a, 101b, 101c, etc. (collectively or generically referred to as processor 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a Read-only memory (ROM) 104 and a Random-access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

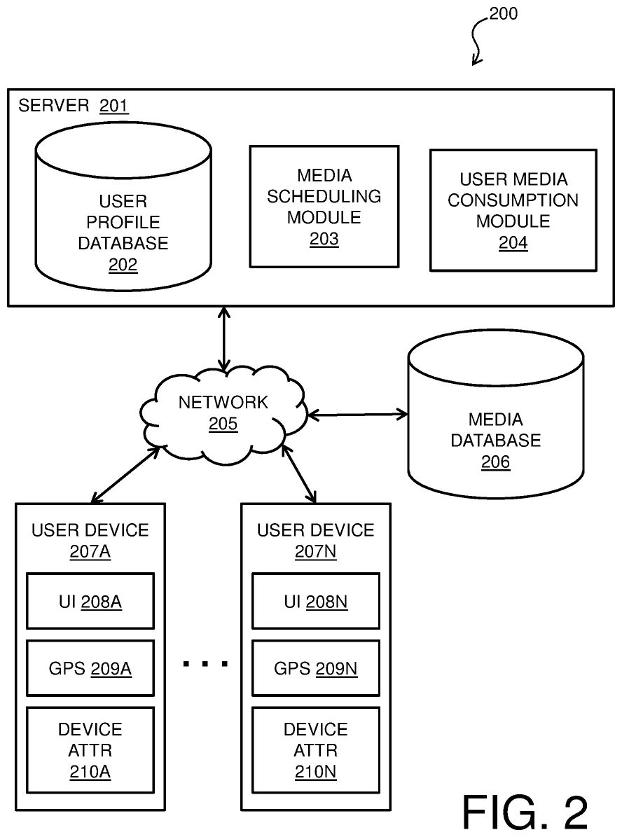

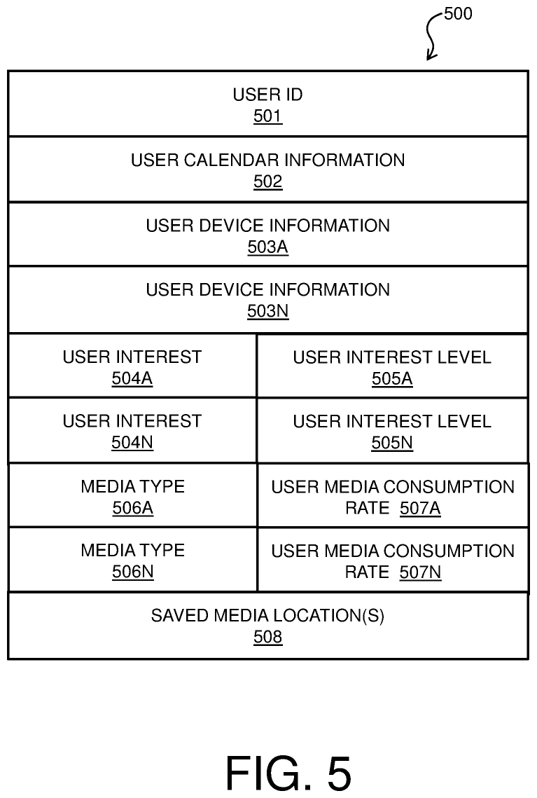

FIG. 2 is a block diagram of a system 200 for media selection and delivery scheduling in accordance with one or more embodiments of the present invention. System 200 includes a server 201, a media database 206, and a plurality of user devices 207A-N connected by a network 205. The server 201 may include any of the elements discussed above with respect to computer system 100 of FIG. 1. Server 201 includes a user profile database 202 that stores a plurality of user profiles, each of the user profiles corresponding to a respective user. A user profile may include any appropriate information corresponding to a user, including but not limited to: a user identifier; one or more device identifiers for any devices that the user has registered with the server 201, including device type (e.g., smartphone, smart television, tablet, in-vehicle entertainment system, etc.) and user preferences regarding media consumption on the device; one or more user interests and a respective corresponding user interest level for each user interest; user calendar information, including future calendar information from one or more calendars associated with the user (e.g., work and personal calendars) and historical user schedule information; and a plurality of user media consumption rates, each user media consumption rate corresponding to a respective media type (e.g., video, podcast, audiobook, e-book, article, tutorial). Information that is included in a user profile in user profile database 202 may be provided by a user during registration with the server 201 via, for example a user device such as user device 207A. An embodiment of a user profile is discussed below with respect to user profile 500 of FIG. 5.

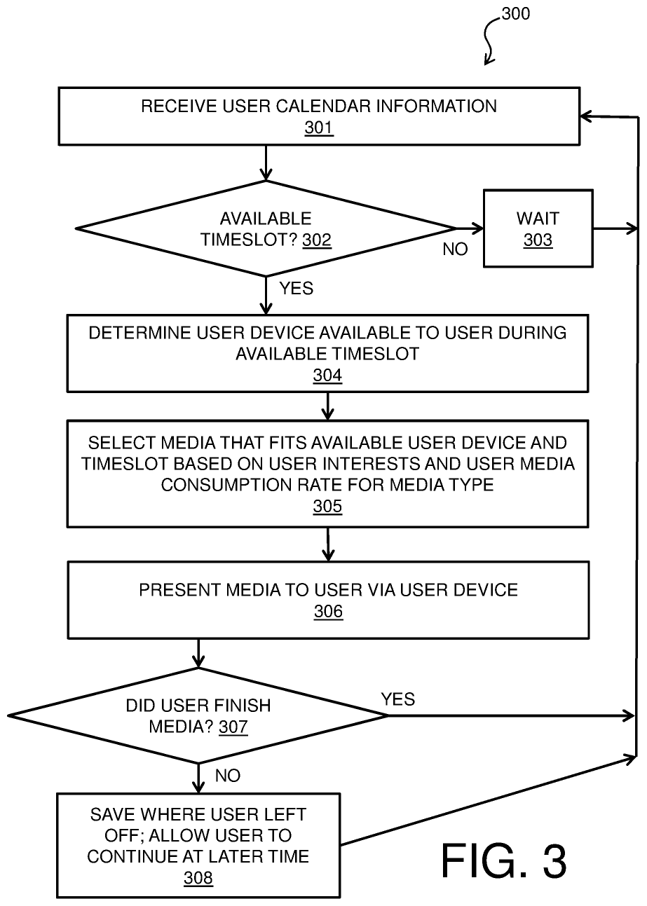

The server 201 further includes a media scheduling module 203. The media scheduling module uses the information stored in the user profiles in the user profile database 202 to schedule delivery of media from media database 206 to users of the system 200 via user devices 207A-N. The media scheduling module 203 may have access to a user's calendar information in the user profile database 202 in order to determine a free timeslot during which the user may wish to receive media. The media scheduling module 203 may also have access to global positioning system (GPS) information from a GPS unit, such as GPS 209A-N, in user devices 207A-N; the GPS information may be used to determine one or more devices, of a plurality of devices that are registered to a particular user, that are physically available to the user during a particular timeslot. The determination of the available device may be used by the media scheduling module 203 to determine a media type for delivery to the user, as some media types may be better suited for consumption on certain types of devices (e.g., the user may prefer to watch a movie on a smart television, listen to a podcast using a smartphone, and/or read an article using a tablet). The media scheduling module 203 may also select media for delivery to a user based on the user interests and corresponding user interest levels that are stored in the user profile in the user profile database 202. The media scheduling module 203 may also access the user media consumption rates in the user profile to determine a length of media that is appropriate for the duration of a particular timeslot based on the media type. The media scheduling module 203 is discussed below in further detail with respect to method 300 of FIG. 3.

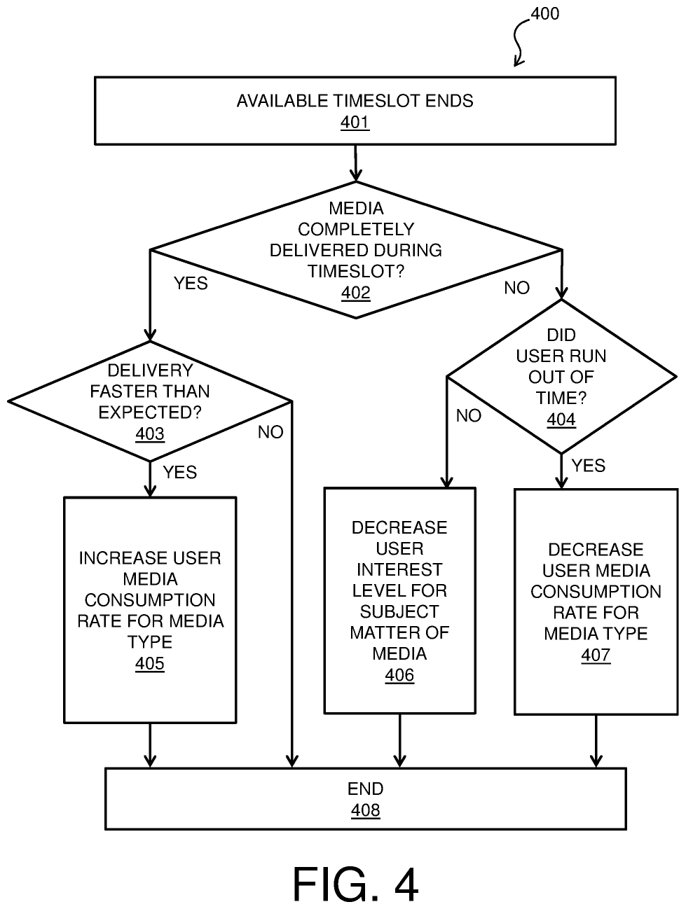

The server 201 further includes a user media consumption module 204. The user media consumption module 204 may learn the rates at which the user consumes different types of media. The user media consumption module 204 tracks the actual media consumption by a user via any of user devices 207A-N, and adjusts various fields in the user profile in user profile database 202, including but not limited to user media consumption rates and/or user interest levels, based on the user's actual media consumption. The user media consumption module 204 is discussed in further detail with respect to method 400 of FIG. 4.

Server 201 is connected to media database 206 and a plurality of user devices 207A-N via network 205. Network 205 may be any appropriate network that may be used for transmission of data and media. Media database 206 may host any appropriate type of media for delivery to any of user devices 207A-N. Media that is stored in media database 206 may include but is not limited to movies, podcasts, articles, tutorials, e-books, and audiobooks. The media in media database 206 may be educational content in some embodiments. In some embodiments, a plurality of media databases such as media database 206 may be in communication with server 201 and user devices 207A-N via network 205, and media from any of the plurality of media databases may be scheduled by server 201 for delivery to any of user devices 207A-N via network 205. Media database 206 may include any of the elements discussed above with respect to computer system 100 of FIG. 1.

User devices 207A-N receive media from media database 206 based on the calendar-based scheduling that is performed in server 201. User devices 207A-N may be any appropriate types of user devices, including but not limited to smart phones, tablets, gaming systems, laptop computers, smart televisions, and in-vehicle entertainment systems. Each of user devices 207A-N may include any of the elements discussed above with respect to computer system 100 of FIG. 1. Each user device 207A-N is shown as including a respective user interface (UI) 208A-N, GPS 209A-N, and device attributes 210A-N. The GPS 209A-N gives the current physical location of a user device 207A-N. In some embodiments, a user device that is in communication with server 201 and media database 206 via network 205 may be a non-mobile device that does not include a GPS such as GPS 209A-N (e.g., a smart television or gaming system), in such embodiments, a static location of the non-mobile device may be stored in the user profile in user profile database 202. Each user device of user devices 207A-N is listed in a user profile in user profile database 202, and a user may have multiple user devices registered to the particular user in their user profile. The information from GPS 209A-N and device attributes 210A-N are shared with the server 201 for a registered user device of user devices 207A-N. Device attributes 210A-N may describe what types of content the user device can receive, and any delivery preferences for particular types of content via the user device. The information in a user profile associated with a user in user profile database 202, including user interests and registered user devices and preferences, may be modified by the user via UI 208A-N. 302

It is to be understood that the block diagram of FIG. 2 is not intended to indicate that the system 200 is to include all of the components shown in FIG. 2. Rather, the system 200 can include any appropriate fewer or additional components not illustrated in FIG. 2 (e.g., additional memory components, embedded controllers, functional blocks, connections between functional blocks, modules, inputs, outputs, GPSs, servers, media databases, networks, user devices, etc.). Further, the embodiments described herein with respect to system 200 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 3 is a process flow diagram of a method 300 for media selection and delivery scheduling in accordance with one or more embodiments of the present invention. Method 300 of FIG. 3 may be implemented in media scheduling module 203 in server 201 of FIG. 2. Method 300 of FIG. 3 may be repeated at any appropriate interval during the operation of the media scheduling module 203. In some embodiments, method 300 of FIG. 3 may be triggered by new user calendar information being available in the user profile database 202. In block 301 of method 300, user calendar information is received from the user profile database 202 by the media scheduling module 203. The user calendar information may include work and personal calendar information. The user calendar information may be provided from a user device 207A to the user profile database 202 in some embodiments. In block 302, it is determined whether there is an available timeslot for media consumption based on the user calendar information that was received in block 301. The user may indicate an available timeslot in block 302 that is not indicated by the calendar information that was received in block 301 in some embodiments. If it is determined in block 302 that there is not an available timeslot, flow proceeds to block 303, in which the media scheduling module 203 waits. Flow then proceeds from block 303 back to block 301 based on, for example, availability of additional user calendar information, or an indication by the user that there is a currently available timeslot.

If it is determined in block 302 that there is an available timeslot, flow proceeds from block 302 to block 304. In block 304, the media scheduling module 203 determines what devices of the user devices 207A-N that are registered to the particular user are physically available to the user during the available timeslot. The determination of block 304 may be made based on historical user device GPS data, and/or historical user schedule data in some embodiments, and may include determining the likely physical location of the user during the available timeslot. For example, if the user has historically been at home during a particular recurring timeslot (e.g., a weekday evening), it may be determined that a smart television is available to the user during the available timeslot. In another example, if it is determined that the GPS of the user's smart phone and the GPS of the user's in-vehicle entertainment system are at the same location during the available timeslot, the smart phone and the in-vehicle entertainment system may be determined to be available to the user during the available timeslot (e.g., during the user's commute).

In block 305, the media scheduling module 203 selects, based on the available device(s) that were determined in block 304 and the duration of the available timeslot, one or more pieces of media content for delivery to the user during the available timeslot. The selection of block 305 may be made based on user interests and corresponding user interest levels that are stored in the user profile in the user profile database 202. The selection may further be made based on a type of media that is appropriate for an available device; these preferences may be set in the user profile (e.g., the user may prefer to read articles on a tablet, or listen to podcasts on a smartphone). In some embodiments, for an available timeslot during which the user is determined to be in a vehicle, the media scheduling module 203 may select audio media. The media is selected in block 305 so as to fit in the amount of time corresponding to the available timeslot based on a user media consumption rate associated with the type of the media that is stored in the user profile (e.g., video, audio, reading, etc.). For example, a user may prefer to listen to podcasts or audio books at an accelerated rate, or may tend to stop and rewatch portions of educational tutorials. An expected media delivery time may be determined in block 305 based on the user media consumption rate, and compared to the duration of the available timeslot. The media is selected in block 305 to be appropriate for the available device and to fit in the available timeslot. In some embodiments, if there are multiple available devices during the available timeslot, the user may be presented with choices of media for the available timeslot corresponding to each of the available devices. The selected media may be educational media in some embodiments.

In block 306, the selected media is presented to the user during the available timeslot. The media that was selected by media scheduling module 203 in block 305 is provided from media database 206 to an available user device 207A via network 205 during block 306. In some embodiments, the user may receive a prompt via a user device 207A before starting the selected media, and, based on the user accepting the selected media in response to the prompt, delivery of the media to the user may commence in block 306. In some embodiments, the prompt may include choices of different pieces of media selected for different available devices of the user, and the user may select one of the choices for delivery in block 306.

In block 307, it is determined whether the user finished consuming the selected media that was delivered in block 306. If it is determined in block 307 that the user did finish the selected media, flow proceeds from block 307 back to block 301, and method 300 is repeated by the media scheduling module 203 to provide further media to the user. If the user finished the selected media before the elapsing of the available timeslot, an additional piece of media may be selected for the remaining available timeslot in a next iteration of method 300.

If it was determined in block 307 that the user did not finish the selected media during the available timeslot, flow proceeds from block 307 to block 308. In block 308, the user's location in the selected media is saved in the user profile, so that the user may resume the selected media at a later time. The remainder of media that was not finished by the user may be selected for presentation to the user starting at the saved location in future iterations of block 305 of method 300. Flow then proceeds from block 308 back to block 301. Method 300 of FIG. 3 may be repeated as appropriate during operation of server 201 of FIG. 2.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

FIG. 4 is a process flow diagram of another method 400 for media selection and delivery scheduling in accordance with one or more embodiments of the present invention. Method 400 of FIG. 4 may be implemented in user media consumption module 204 in server 201 of FIG. 2. In block 401 of method 400, an available timeslot in which a user has been consuming media from media database 206 that was selected by media scheduling module 203 via a user device, such as user device 207A, ends. In block 402, the user media consumption module 204 determines whether the selected media was completely delivered to the user during the available timeslot (i.e., the user finished consuming the selected media). If it is determined in block 402 that the selected media was completely delivered, flow proceeds from block 402 to block 403.

In block 403 of method 400, it is determined whether the delivery of the selected media was faster than expected (e.g., the selected media was fully consumed by the user before the elapsing of the available timeslot). If it is determined in block 403 that the delivery of the selected media was faster than expected, flow proceeds from block 403 to block 405. In block 405, the user media consumption rate for the particular media type corresponding to the selected media is increased in the user profile in user profile database 202. The increase of block 405 may be determined based on a difference between an expected media delivery time (e.g., determined based on the current user media consumption rate) and the actual media delivery time. For example, if the media scheduling module 203 predicted that it would take the user 15 minutes to read an article, and the user closed a tab containing the article after 9 minutes after being opened, the user media consumption rate corresponding to reading of articles may be adjusted based on the 6 minute time difference. In some embodiments, multiple user media consumption rates for the same type of media may be maintained, each of the multiple user media consumption rates corresponding to a different user interest. Flow then proceeds from block 405 to block 408, and method 400 ends. If it was determined in block 403 that the delivery was not faster than expected, flow proceeds from block 403 to block 408, and method 400 ends.

If it was determined in block 402 that the selected media was not completely delivered during the available timeslot, flow proceeds from block 402 to block 404. In block 404, it is determined whether the user ran out of time (e.g., as opposed to stopping consumption of the selected media). In some embodiments, the user may be prompted in block 404 via a user device to tell the server 201 whether the user did not finish the selected media due to, for example, loss of interest, or if the user ran out of time. If it is determined in block 404 that the user did not run out of time, flow proceeds from block 404 to block 406, in which the user interest level of the user interest corresponding to the selected media is decreased. The decreasing of the user interest level in block 406 may cause the media scheduling module 203 to recommend less media corresponding to that user interest in the future. Flow then proceeds from block 406 to block 408, and method 400 ends. If it was determined in block 404 that the user did run out of time, flow proceeds from block 404 to block 407. In block 407, the user media consumption rate corresponding to the media type of the selected media is decreased. The amount of the decrease of block 407 may be determined based on an amount of the selected media that was not consumed. Flow then proceeds from block 407 to block 408, and method 400 ends. Method 400 of FIG. 4 may be triggered whenever an available timeslot during which selected media is delivered, such as is identified by method 300 of FIG. 3, ends.

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

FIG. 5 is a block diagram of a user profile 500 for use in a system, such as system 200 of FIG. 2, for media selection and delivery scheduling in accordance with one or more embodiments of the present invention. A plurality of user profiles such as user profile 500 may be stored in user profile database 202 of server 201 of FIG. 2. A user profile 500 may be created in user profile database 202 for a user based on a user registering with the server 201; in some embodiments, registering may include downloading an app to a user device 207A. The user profile 500 includes a user identifier (ID) 501 and user calendar information 502. The user calendar information 502 may be collected from any calendars associated with a user, including but not limited to a work calendar and a personal calendar. The user calendar information 502 may also include historical user schedule information and location data for use in determining the likely location of a user during a particular timeslot, as is performed in block 304 of method 300 of FIG. 3.

The user profile further includes user device information 503A-N. Each instance of user device information 503A-N may correspond to a different user device, such as user devices 207A-N; a single user may be associated with any appropriate number of user devices. User device information such as user device information 503A may include any appropriate information regarding the corresponding device, including but not limited to device type, device characteristics, and location information such as current GPS information and historical GPS information, or, for a non-mobile user device, a device location (e.g., home or office). Examples of user device types that may have associated user device information such as user device information 503A-N include but are not limited to smart phones, tablets, gaming systems, laptop computers, smart televisions, and in-vehicle entertainment systems. User device information 503A-N may also include, for each device, types of media that the user prefers to consume using the device (e.g., the user may prefer to watch a movie on a smart television or listen to a podcast via a smartphone).

The user profile 500 further includes a plurality of user interests 504A-N, each having a corresponding user interest level 505A. The user interests 504A-N and user interest levels 505A-N may be initially set by the user. The user interests 504A-N may be used to select particular media in block 305 of method 300 of FIG. 3. The user interest levels 505A-N may be adjusted as described above with respect to block 406 of method 400 of FIG. 4.

The user profile 500 further includes a plurality of media types 506A-N, each having a corresponding user media consumption rate 507A-N. Media types that may be included in media types 506A-N include but are not limited to video, audio, and reading. The user media consumption rates 507A-N may be adjusted as described above with respect to block 405 and block 407 of method 400 of FIG. 4. In some embodiments, a single media type 506A may be associated with multiple user media consumption rates 507A-N, each of the multiple user media consumption rates corresponding to a respective user interest 504A-N. User profile 500 further includes saved media location(s) 508, which may include one or more locations in selected media for resumption at a later time, as described above with respect to block 308 of method 300 of FIG. 3.

FIG. 5 is shown for illustrative purposes only. Embodiments of a user profile such as user profile 500 may include any appropriate fields to hold any appropriate information in any appropriate order.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system comprising a processor configured to:
determine an available timeslot corresponding to a user based on a calendar that is associated with the user;
determine a user device that is available to the user during the available timeslot;
select media for consumption by the user during the available timeslot via the available user device; and
cause the selected media to be delivered to the user via the available user device during the available timeslot.

2. The system of claim 1, wherein the available user device is determined based on location data of the user device and historical schedule information of the user.

3. The system of claim 1, wherein the media for consumption by the user is selected based on a type of the available user device, a user interest, a user media consumption rate, and a duration of the available timeslot.

4. The system of claim 3, wherein selecting the media for consumption by the user based on the type of the available user device comprises determining a type of media that is appropriate for consumption via the available user device.

5. The system of claim 4, wherein selecting the media for consumption by the user based on the user media consumption rate and the duration of the available timeslot comprises:
determining an expected media delivery time for the type of media based on the user media consumption rate, the user media consumption rate corresponding to the type of media; and
comparing the expected media delivery time to the duration of the available timeslot.

6. The system of claim 5, the processor configured to, based on elapsing of the available timeslot:
determine whether the selected media was completely delivered to the user during the available timeslot;
based on determining that that the selected media was completely delivered to the user during the available timeslot, determine whether delivery of the selected media was faster than the expected media delivery time; and
based on determining that delivery of the selected media was faster than the expected media delivery time, increase the user media consumption rate.

7. The system of claim 6, the processor configured to:
based on determining that the selected media was not completely delivered to the user during the available timeslot, determine whether the user ran out of time;
based on determining that the user ran out of time, decrease the user media consumption rate; and
based on determining that the user did not run out of time, decrease a user interest level corresponding to the user interest.

8. A computer-implemented method, comprising:
determining, by a processor, an available timeslot corresponding to a user based on a calendar that is associated with the user;
determining a user device that is available to the user during the available timeslot;
selecting media for consumption by the user during the available timeslot via the available user device; and
causing the selected media to be delivered to the user via the available user device during the available timeslot.

9. The computer-implemented method of claim 8, wherein the available user device is determined based on location data of the user device and historical schedule information of the user.

10. The computer-implemented method of claim 8, wherein the media for consumption by the user is selected based on a type of the available user device, a user interest, a user media consumption rate, and a duration of the available timeslot.

11. The computer-implemented method of claim 10, wherein selecting the media for consumption by the user based on the type of the available user device comprises determining a type of media that is appropriate for consumption via the available user device.

12. The computer-implemented method of claim 11, wherein selecting the media for consumption by the user based on the user media consumption rate and the duration of the available timeslot comprises:
determining an expected media delivery time for the type of media based on the user media consumption rate, the user media consumption rate corresponding to the type of media; and
comparing the expected media delivery time to the duration of the available timeslot.

13. The computer-implemented method of claim 12, the method comprising, based on elapsing of the available timeslot:
determining whether the selected media was completely delivered to the user during the available timeslot;
based on determining that that the selected media was completely delivered to the user during the available timeslot, determining whether delivery of the selected media was faster than the expected media delivery time; and
based on determining that delivery of the selected media was faster than the expected media delivery time, increasing the user media consumption rate.

14. The computer-implemented method of claim 13, the method comprising:
based on determining that the selected media was not completely delivered to the user during the available timeslot, determining whether the user ran out of time;
based on determining that the user ran out of time, decreasing the user media consumption rate; and
based on determining that the user did not run out of time, decreasing a user interest level corresponding to the user interest.

15. A computer program product comprising:
a computer readable storage medium having program instructions embodied therewith, the program instructions executable by a processing device to cause the processing device to perform a method comprising:
determining an available timeslot corresponding to a user based on a calendar that is associated with the user;
determining a user device that is available to the user during the available timeslot;
selecting media for consumption by the user during the available timeslot via the available user device; and
causing the selected media to be delivered to the user via the available user device during the available timeslot.

16. The computer program product of claim 15, wherein the available user device is determined based on location data of the user device and historical schedule information of the user.

17. The computer program product of claim 15, wherein the media for consumption by the user is selected based on a type of the available user device, a user interest, a user media consumption rate, and a duration of the available timeslot.

18. The computer program product of claim 17, wherein selecting the media for consumption by the user based on the type of the available user device comprises determining a type of media that is appropriate for consumption via the available user device.

19. The computer program product of claim 18, wherein selecting the media for consumption by the user based on the user media consumption rate and the duration of the available timeslot comprises:
determining an expected media delivery time for the type of media based on the user media consumption rate, the user media consumption rate corresponding to the type of media; and
comparing the expected media delivery time to the duration of the available timeslot.

20. The computer program product of claim 19, the method comprising, based on elapsing of the available timeslot:
determining whether the selected media was completely delivered to the user during the available timeslot;
based on determining that that the selected media was completely delivered to the user during the available timeslot, determining whether delivery of the selected media was faster than the expected media delivery time; and
based on determining that delivery of the selected media was faster than the expected media delivery time, increasing the user media consumption rate.
